(19) United States
(12) Patent Application Publication
(10) Pub. No.: US 2006/0156296 A1
(43) Pub. Date: Jul. 13, 2006

(54) Distributed computing system

(76) Inventor: Athomas Martin Goldberg, Oakland, CA (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/508,651

(22) PCT Filed: Mar. 24, 2003
(86) PCT No.: PCT/US03/09084

§ 371 Date: Aug. 1, 2005

Related U.S. Application Data
(60) Provisional application No. 60/366,753, filed on Mar. 22, 2002.

(51) Int. Cl. G06F 9/44

(52) U.S. Cl. 717/168

(57) ABSTRACT

A distributed computing system includes a first discreet component application (100) instantiated on a first peer of a peer-to-peer network and a first run-time environment residing on the first peer. The discreet component application includes a component (102) and a container (104) configured for providing management services to the component. Lightweight, self-contained, portable network services may be provided and managed remotely, and modified and updated at run-time.

### BACKGROUND

The present invention relates to peer-to-peer computing systems in general, and, in particular, to a distributed computing system using discreet component applications.

Existing products in the distributed component space fall into two major categories: centralized application servers and distributed object frameworks. Application servers employ a “thin-client” model in which business logic and presentation components are hosted on a centralized server and accessed through a lightweight client (usually a web browser). A component is typically understood to be a self-contained piece of functionality which provides a specific service.

Distributed object frameworks, such as the Common Object Request Broker Architecture (CORBA) standards-based distributed component model proposed by the Object Management Group (OMG) and the Distributed Component Object Model (DCOM) of Microsoft Corporation, are used in “fat-client” applications where software installed on each client machine connects to a specific service or set of services hosted on one or more remote devices. DCOM enables developers to build applications, where various components are executed on different network machines. Unfortunately DCOM is geared towards those devices using Microsoft operating systems. Furthermore, the use of COM requires a strict prior knowledge of exact components through their unique identifiers (UUID).

Jini™ network technology provides simple mechanisms for enabling devices to plug together, forming impromptu “communities”. Each device provides services for use by other devices in the community.

Enterprise JavaBeans™—Enterprise JavaBeans™ (EJB) support the standard, now ubiquitous, three-tier architecture. It uses a central server, connected to a database, and abstracts many concurrent and database programming and transaction-based computing issues used to construct three-tier applications.

It is becoming increasingly more common these days for enterprises to have very mobile and geographically distributed workforces. In order for this workforce to operate effectively and efficiently, they need to share the same applications and data. This puts an increasing demand on the IT organizations within these enterprises to provide the workforce with the same application functionality wherever they may be and on whatever device they may be using (PCs, Laptops, PDA, wireless phones, etc.). Generally, this means that applications have to be designed a number of times to meet the CPU requirements and resource constraints of the various devices employed by the workforce as well as the underlying network architecture.

Succeeding in today's dynamic economy is becoming ever more dependent on how well businesses communicate across internal and external customers and the devices, applications and systems they use. Constantly changing business processes and relationships brought about by an increasingly mobile and dispersed workforce and the economic necessity to build efficiencies through mergers, acquisitions and partnerships has only added complexity to this challenge.

Distributed applications that enable companies to communicate more effectively across boundaries, adapt to change and scale to meet increasing demand are a necessity. Businesses have adopted a variety of technologies from application servers to Web services platforms to build and deploy distributed applications. However, these technologies only offer a partial solution—still requiring a great deal of time and effort to develop, they are expensive to deploy and are inflexible to change, manage and grow along with the business.

The vast majority of Web services platforms, tools and technologies, are geared toward the creation and management of a service or set of services running on a single host. While there are tools to enable the creation of applications that make use of a diverse set of independently hosted services, (i.e. Microsoft's Studio.NET) none of these address the issue of managing collections of services running on a wide variety of devices and the interconnections between them. Traditionally, meeting the increased demand on network based applications meant adding additional resources to the network (i.e. more servers).

In prior application servers and distributed object frameworks, functionality must be designed, deployed and maintained to specifically address the hardware, transport and communications requirements of the underlying network architecture. Furthermore, objects making up a component must be assembled and compiled together before run-time.

### SUMMARY OF THE INVENTION

In accordance with a first embodiment of the present invention, a discreet component application is provided. The discreet component application includes a component and a container configured for providing management services to the component.

In accordance with a second embodiment of the present invention, a distributed computing system is provided. The distributed computing system includes a first discreet component application instantiated on a first peer of a peer-to-peer network and a first run-time environment residing on the first peer.

In accordance with a third embodiment of the present invention a method for managing a component in a distributed computing system is provided. The method includes providing the component with a container configured for providing management services to the component so as to form a discreet component application;

modifying configuration data of the component using configuration data obtained from a discreet application database.

In accordance with a fourth embodiment of the present invention, an apparatus for dynamically reconfiguring a capability of a component in a distributed computing system is provided. The apparatus includes:

a container configured for providing management services to the component so as to form a discreet component application;

a discreet component application configuration information modification program configured for making configuration changes to the discreet component application;

a run-time environment configured for managing communications with the discreet component application and for instantiating the discreet component application on a peer of a peer-to-peer network;

a discreet component application database configured for storing a code-base of the discreet component application; and a discreet component application registry configured for at least one of 1) managing communication between the first run-time environment and the discreet component application database, 2) locating and retrieving discreet component applications from the discreet component application database, and 3) propagating configuration data regarding the first discreet component application to the first circuit run-time environment.

In accordance with a fifth embodiment of the present invention, a computer readable medium having stored thereon computer executable process steps operative to perform a method for managing a component in a distributed computing system is provided. The method includes:

providing the component with a container configured for providing management services to the component so as to form a discreet component application; and

modifying configuration data of the component using configuration data obtained from a discreet application database.

In accordance with a sixth embodiment of the present invention, a distributed computing system is provided. The distributed computing system includes:

a first discreet component application instantiated on a first peer a peer-to-peer network;

a first run-time environment residing on the first peer; and

a discreet component application registry.

The present invention provides lightweight, self-contained, portable network services that may be managed remotely, modified and updated at run-time. The services may be hosted on dedicated peers or servers on the network, dynamically migrated across multiple peers to provide efficient load management, or downloaded to client devices, as needed to provide rich user interactions and distributed processing.

### BRIEF DESCRIPTION OF THE DRAWINGS

FIG. 1 shows a schematic diagram of a discreet component application according to the present invention.

FIG. 2 shows a schematic block diagram of a distributed computing system according to the present invention for communicating between two instantiated discreet component applications residing on a same peer.

FIG. 3 shows a schematic block diagram of a distributed computing system according to the present invention for communicating between two instantiated discreet component applications residing on separate peers.

FIG. 4 shows a schematic block diagram of a distributed computing system according to the present invention for communicating between two discreet component applications residing on separate peers with one of the discreet component applications not being initially instantiated.

FIG. 5 shows a schematic block diagram of a system for dynamically reconfiguring a discreet component application in a distributed computing system.

FIG. 6 shows a schematic block diagram of a peer-to-peer network on which a system for dynamically reconfiguring a discreet component application in a distributed computing system resides.

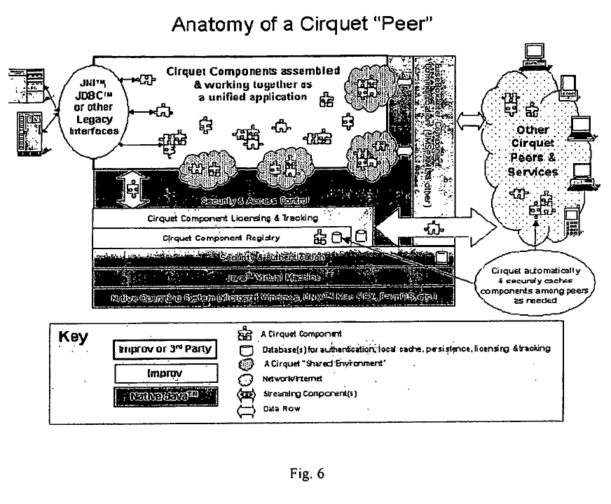

### DETAILED DESCRIPTION

As described above, the present invention provides a discreet component application. The discreet component application includes a component; and a container configured for providing management services to the component.

In accordance with a second embodiment of the present invention, a distributed computing system is provided. The distributed computing system includes a first discreet component application instantiated on a first peer of a peer-to-peer network and a first run-time environment residing oil the first peer.

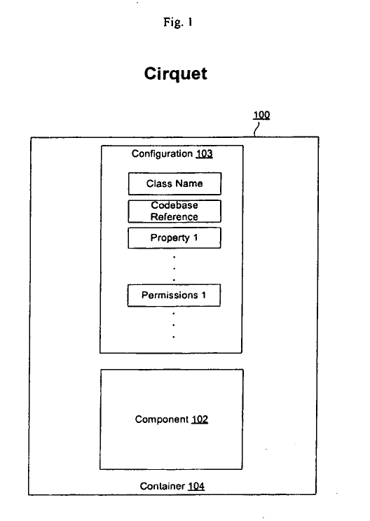

FIG. 1 shows a schematic diagram of a discreet component application 100 according to the present invention. Discreet component application 100 includes component 102, configuration 103 and container 104. Discreet component application 100 may carry the name “Cirquet™”, which is a trademark of Improv Technologies, Inc., the assignee of the present invention.

Component 102 represents the business logic, presentation logic or other software functionality. Component 102 may be a self-contained piece of functionality which provides a specific service. Component 102 may be a set of software code that has an interface and performs a specific function for a requester. Component 102 may be made up of a number of objects. Component 102 includes a code base written in any suitable programming language. The code base of component 102 may be written in Java, for example.

Container 104 “holds” a) the configurable properties of component 102, b) references to the code base the class files of the component, and c) the access control information to the component. These are indicated in FIG. 1 by configuration 103 and can be dynamically configured at run-time. The container also is extensible so that new services can be binded to it at run-time. Configuration 103 may be an object and the configurable properties, refrences, access control information may be objects themselves.

Container 102 receives messages, such as request messages. Container 102 determines:

Whether or not the Cirquet can support the message request.

Whether or not the sender of the message has permission to make a request on the Cirquet.

Whether or not the message is an “update property” request.

A message received by container 102 may be an “update property” request message. If so, container 102 will:

Capture the state of the component. The “state” is the values of the properties of the component different from the original configuration at the time the “update properties” request is received.

Update the properties in the container.

Then update the properties of component 102.

Then place the stored state information back into component 102.

Container 104 resides on the same peer with component 102. A programmer does not need to write a container. The container is created in the language of the cirquet system, in the first implementation is java, but could be implemented using any object-oriented language.

The configuration information data of component 102 may be modified as follows:

The cirquet registry broadcasts a message to all run-time environments hosting and/or accessing the Cirquet notifying of the change.

Each run-time environment receives the new Cirquet configuration data (closest thing to code) and instantiates a cirquet container and configures the container based on the configuration data.

The container then instantiates the component based on the configuration data.

Container 104 may be an object created (instantiated) by the cirquet run-time environment and is stored in the memory cache of the cirquet run-time. When the cirquet run-time environment gets the configuration information data of a cirquet from the cirquet registry/cirquet database, creates the cirquet container then calls a “configure” method on the container passing it the configuration information data creating the container. The container loads the class and creates an instance of the class so as to form component 102, sets the properties on the instance and sets permissions.

When a message arrives, the cirquet run-time environment calls a handle request method on the container, passing it the message. The container first checks the class to see if a corresponding method exists, if so, it invokes the method on the component. If it returns a value, it creates a response message and passes it back to the run-time.

When the cirquet run-time environment receives an update message, it calls the update method on the container. The container saves the state to the state manager, reads in configuration. If the class or codebase is modified/changed, then the container re-instantiates the component; otherwise, the container modifies the changed properties. the container then reloads the state information.

Discreet component application, or Cirquet, 100 may reside on any peer of a peer-to-peer network or other network. The network may have any number of peers. All of some of the peers of the network may be interconnected via the Internet. All or some of the peers may be interconnted via any suitable type of network providing connectivity. A peer may be any personal computer (PC) or workstation, server, mainframe personal digital assistant (PDA, Internet-enabled phone, smart-card, or other suitable device. Discreet component application 100 may be instantiated or not instantiated. Instantiated is here intended to mean constructed and/or running on a peer. Any number of individual discreet component applications may be distributed throughout a network. More than one discreet component application may reside on a peer of a network. A given discreet component application may be resident (duplicated) on more than one peer. Each discreet component application 100 may provide a specific service, such as a web service, for example.

Among the general scenarios which may be envisioned involving one or more Cirquets 100 are the following:

Two or more instantiated Cirquets on the same peer communicating with each other

Two or more instantiated Cirquets residing on different peers communicating with each other

One or more instantiated Cirquets and one or more “to be” instantiated Cirquets residing on the same peer

One or more instantiated Cirquets residing on different peers communicating with one or more “to be” instantiated Cirquets residing on different peers

Configuration change of a Cirquet.

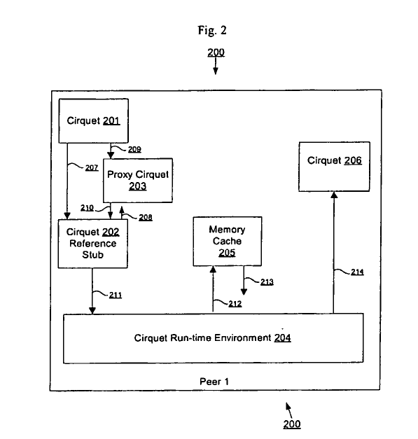

FIG. 2 shows a schematic block diagram of a distributed computing system 200 according to the present invention for communicating between two instantiated discreet component applications 201, 206 residing on a common peer 220 of peer-to-peer network 450. Peer 220 includes a memory cache 205. Discreet component applications 201 and 206 are resident on peer 220 and, as noted above are instantiated on the peer.

Cirquet reference stub 202 represents Cirquet 206 and maintains a pointer to the location of Cirquet 206, which may be in this case referred to as the “target” Cirquet. Cirquet reference stub 202 resides on peer 220 and shares with Cirquet 201 circuit run-time environment 204 (or any instantiated Cirquet that sends a message to cirquet reference stub 202). When an “invoke” method (see below) is called on cirquet reference stub 202, the cirquet reference stub creates a message containing the name of the method, the arguments associated with the method and the destination of the Cirquet it references and passes this message to run-time environment 204. When a “narrow” method (see below) is called, cirquet reference stub 202 creates proxy cirquet 203. The proxy cirquet

Proxy Cirquet 203 is created by Cirquet reference stub 202 when the Cirquet reference stub receives a “narrow” method call from instantiated Cirquet 201. Proxy Cirquet 203 implements the interface of Cirquet 206 represented by Cirquet reference stub 202 so that Proxy Cirquet 203 implements the same methods that Cirquet 206 implements. When a method is called on Proxy Cirquet 203, an “invoke” method is called on cirquet reference stub 202. Cirquet reference stub 202 then passes on a message containing the name of the method, the associated arguments, and the destination information of Cirquet 206.

Cirquet run-time environment 204 is an environment, or application resident and running on peer 220. Cirquet run-time environment 204 monitors network 450 incoming messages and packages outgoing messages. Cirquet run-time environment 204 may be written in any object-oriented language, such a Java, for example. Cirquet run-time environment 204 has the following capabilities:

Managing and directing communications between Cirquets, residing either locally on the same peer or remotely on one or more external peers.

Instantiating Cirquets on local peer.

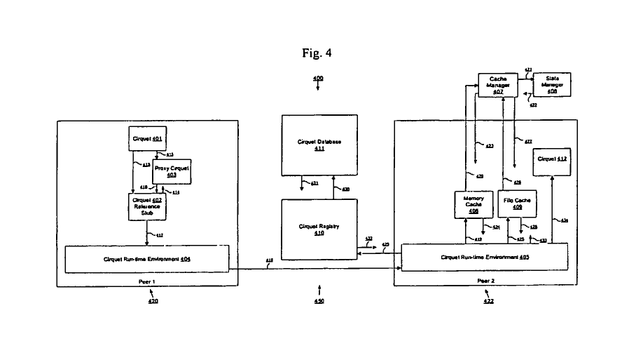

Cirquet run-time environment 204 is capable of constructing container 104 and configuring the container based on configuration data received from Cirquet registry 410 (see FIG. 4). Container 104 constructs component 102 as an instance of the component class from the codebase, which resides in a separate directory.

Peer 220 has local memory cache 205, representing the memory storage of the peer.

Example 1 below describes the process by which a message is sent from one Cirquet 201 to Cirquet 206 on peer 220.

### EXAMPLE 1

Instantiated Cirquet 201 either sends:

An “invoke” call on Cirquet reference stub 202, or

A “narrow” call on a Cirquet reference stub 202.

If a “narrow” call is made from Cirquet 201 to Cirquet reference stub 202, the Cirquet reference stub returns Cirquet proxy 203. If an “invoke” call is made from Cirquet 201 to Cirquet reference stub 202, the Cirquet reference stub creates a message containing the method name, the associated arguments and the destination information of Cirquet 206.

Proxy Cirquet 203 implements the interface of Cirquet 206 so that it implements the same methods that Cirquet 206 implements.

Once proxy cirquet 204 is implemented, the instantiated Cirquet (201) is able to send a method call to it. Because proxy cirquet 204 implements the interface containing the same methods as target Circuet 206, Cirquet 201 can make method calls on proxy cirquet 204. Proxy circuet 204 makes an “invoke” call on the cirquet referencing stub.

The Cirquet proxy (203) reacts to the method call from the instantiated Cirquet (201) and “invokes” a call on Cirquet reference stub (202).

The Cirquet reference stub (202) sends a message containing the method name and the associated arguments, along with the destination (location) information of the target Cirquet (206) it represents, to the Cirquet run-time environment (204). In this example, the Cirquet location indicates the local peer 220.

The Cirquet run-time environment (204) checks the local memory cache to see if the target Cirquet (206) is instantiated.

The local memory cache (205) returns back to the Cirquet run-time environment (204) either a reference to the Cirquet (206), meaning that Cirquet 206 is instantiated, or a “null” value if it is not. In this example, target Cirquet 206 is instantiated and its location is on the local peer 220.

The Cirquet run-time passes the original message from Cirquet (201) to the instantiated Cirquet (206).

Communications, or messages, between entities are as follows:

between the instantiated cirquet and the cirquet reference stub, the message is in the form of a method call—either “invoke” or “narrow”.

Between the cirquet reference stub and the cirquet run-time, the message contains the name of the method, the associated arguments and the destination information of the target cirquet.

The message between the cirquet run-time and the local cache is in the form of a method call.

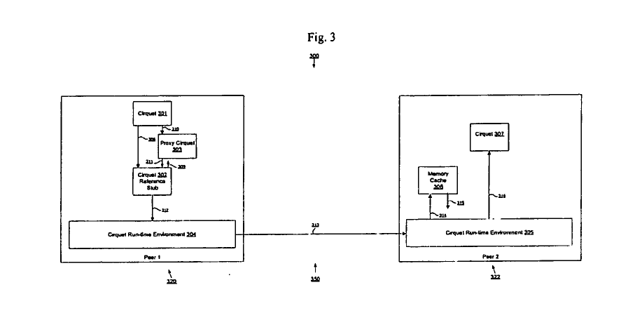

FIG. 3 shows a schematic block diagram of a distributed computing system 300 according to the present invention for communicating between two instantiated discreet component applications 301, 307 residing on separate peers 320 and 322, respectively, of peer-to-peer network 350.

Cirquet reference stub 302 maintains a pointer to the location of Cirquet 307.

Peer 320 may or may not contain proxy Cirquet 302. A Proxy Cirquet is implemented by a Cirquet reference stub (302) when it receives a “narrow” method call from an instantiated Cirquet (301). The proxy Cirquet implements the interface of the Cirquet referenced by the Cirquet reference stub (302), in this embodiment, Cirquet (301).

Cirquet run-time environments 304 and 305 reside on peers 320 and 322, respectively. Cirquet run-time environments 304 and 305 have capabilities as Cirquet run-time environment 204, described above.

Peer 322 has local memory cache 306. Memory cache 306 represents the memory storage of peer 322.

Example 2 describes the process by which a message is sent from instantiated Cirquet 301 on peer 320 to instantiated Cirquet 307 on peer 322.

Instantiated Cirquet 301 either sends:

An “invoke” call on a Cirquet reference stub (302), or

A “narrow” call on a Cirquet reference stub (302)

If a “narrow” call is made from the Cirquet (301) to the Cirquet reference stub (302), the Cirquet reference stub (302) implements a Cirquet proxy (303).

Once a Cirquet proxy (303) is implemented, the instantiated Cirquet (301) is able to send a method call to it. The Cirquet proxy (303) converts the method call from the instantiated Cirquet (301) into a message and passes it to the Cirquet reference stub (302).

The Cirquet reference stub (302) sends the message to the Cirquet run-time environment (304) along with the location information of the target Cirquet (307) it represents. If the Cirquet reference stub (302) indicates that the location of the target Cirquet (307) is on a remote peer, the Cirquet run-time environment (304) will automatically package the message so that it can be sent across network 350 to the Cirquet run-time environment (305) of the remote peer. Packing means serializing the message, i.e., converting it into binary or text data, such as XML, so that the message can be sent over network 350.

The Cirquet run-time environment (305) on the remote peer checks the local memory cache to see if the Cirquet is instantiated.

The local memory cache (306) on the remote peer sends a message back to the Cirquet run-time environment (305) of the remote peer informing it that the Cirquet (307) is instantiated and it's location.

The Cirquet run-time environment (305) passes the original message from the instantiated Cirquet (301) to the instantiated Cirquet (307).

FIG. 4 shows a schematic block diagram of a distributed computing system 400 according to the present invention for communicating between two discreet component applications, or Circuets, 401, 412 residing on separate peers 420, 422, respectively, with one of the Circuets (Circuet 412) not being initially instantiated. Additional peers may be provided (not shown).

Cache manager 407 is provided for managing memory cache 406 of peer 422. Cache manager may reside locally on or remotely from peer 422.

State manager 408 contains state information of one or more Cirquets once it has been released. The state information includes values of the properties of the respective Circuet that are different from the original configuration at the time the respective Cirquet was instantiated. State manager 408 can reside locally on or remotely from peer 422.

Local file cache 409 represents the file system of peer 422.

Cirquet registry 410 is the interface to the cirquet database (see below). The registry manages retrieving, storing and updating the configuration information data of cirquets. The registry communicates with the database by calling methods on the database. The registry can be implemented in any object oriented language, such as Java, for example. Circuet registry 410 may reside on any peer of network 450.

In some embodiments of the present invention, more than one cirquet registries 410 may be provided the cirquet registry can be replicated to provide a number of different locations from which the cirquet configuration data can be accessed. This may be done to provide load balancing (to prevent bottle-necking). Replicated registries communicate with each other in order to synchronize data. Different cirquet configuration information data can be accessed from different registries. Unless replicated, the registry does not communicate with registries with different cirquet configuration data information.

Cirquet registry 410 provides the following functionality:

Manages the communication between the Cirquet run-time environment and the Cirquet Database.

Locates and retrieves Cirquets from the Cirquet database (see below).

Propagates Cirquet configuration data to the Cirquet run-time environments hosting and/or accessing the Cirquet.

Cirquet database 411 stores the configuration information data of one or more Cirquets. Circuet database 411 may reside on any peer of network 450, and may be distributed among a number of peers. Cirquet database 411 may be any suitable type of database and may be implemented in any suitable language.

Example 3 describes the process by which a message is sent from instantiated Cirquet 401 on one peer to instantiated Cirquet 412 on another peer.

### EXAMPLE 3

Instantiated Cirquet 40) either sends:

An “invoke” call on a Cirquet reference stub (402), or

A “narrow” call on a Cirquet reference stub (402)

If a “narrow” call is made from the Cirquet (401) to the Cirquet reference object (402), the Cirquet reference stub (402) implements a Cirquet proxy (403). Once a Cirquet proxy (403) is implemented, the instantiated Cirquet (401) is able to send a method call to it.

The Cirquet proxy (403) converts the method call from the instantiated Cirquet into a message and passes it to the Cirquet reference stub (402).

The Cirquet reference stub (402) sends the message to the Cirquet run-time environment (404) along with the location information of the target Cirquet it represents.

If the Cirquet reference stub (402) indicates that the location of the target Cirquet is on a remote peer, the Cirquet run-time environment (404) will automatically package the message so that it can be sent across the Internet to the Cirquet run-time environment (405) of the remote peer.

The Cirquet run-time environment (405) will first check to see if the target Cirquet (412) has been instantiated on the local peer. In this embodiment, the target Cirquet (412) has not been instantiated yet. If the target Cirquet (412) is not instantiated on the local peer, the Cirquet run-time environment will first check the local memory cache (406) to see if it contains the configuration data of the target Cirquet (412).

If the target Cirquet's (412) configuration data is present in the local memory cache (406), it will check with the cache manager (407) to see if there is enough room in local memory to instantiate the target Cirquet (412). If space needs to be allocated to instantiate the target Cirquet (412), the cache manager (407) will determine what other Cirquets need to be released from memory. Before releasing a Cirquet from local memory cache (406), the cache manager (407) will send a message containing the state information of the Cirquet to a state manager (408).

The state manager (408) will store the state information of the Cirquet being released and then send a message back to the cache manager (407) indicating that it is safe to release the Cirquet.

The cache manager (407) will send a message to the local memory cache (406) directing it to release or maintain a Cirquet in local memory.

The local memory cache (406) will send a message to the Cirquet run-time environment (405) of the local peer indicating whether or not it has the configuration data of the target Cirquet. If the target Cirquet is not instantiated, the Cirquet run-time environment (405) will first instantiate it and then it will pass the message from the original Cirquet (401) to instantiated target Cirquet (412).

If the target Cirquet's (412) configuration data does not reside in the local memory cache of the local peer, the Cirquet run-time environment (405) will check to see if it resides in the file cache (409) of the local peer. If the local peer does not contain a file cache, then the Cirquet run-time environment (405) will communicate with the Cirquet registry (410) to retrieve the configuration information data of the target Cirquet. The Cirquet registry (410) communicates with the Cirquet database (411) to retrieve if the configuration data of the target Cirquet (412). The Cirquet Registry (410) will send the latest configuration data of the target Cirquet (412) to the Cirquet run-time environment (405) of the local peer. If the target Cirquet is not instantiated, the Cirquet run-time environment (405) will first instantiate it and then it will pass the message from the original Cirquet (401) to instantiated target Cirquet (412).

If the target Cirquet's configuration data resides in the local file cache (409) it will check with the cache manager (407) to see if there is enough room in local memory to instantiate the target Cirquet (412). See 421 and 422 for next steps before continuing with 427. [I need to insert those steps here]

The cache manager (407) will send a message to the local file cache (409) directing it to release or maintain a Cirquet.

The file cache (409) will send a message to the Cirquet run-time environment (405) on the local peer indicating whether or not it has the configuration data of the target Cirquet (412). Whether or not the file cache (408) contains the configuration data of the target Cirquet (412), the Cirquet run-time environment (405) will communicate with the Cirquet registry (410) that maintains the configuration data of the target Cirquet (412) to see if the target Cirquet configuration data is up-to-date or valid.

The Cirquet registry (410) communicates with the Cirquet database (411) to determine if the configuration data of the target Cirquet (412) in the file cache (409) is up-to-date and valid.

The Cirquet database (411) sends message back to the Cirquet registry (410) indicating whether or not the target Cirquet (412) is up-to-date and valid.

If the target Cirquet (412) is up-to-date and valid, the Cirquet registry (410) will send a message to the Cirquet run-time environment (405) indicating so. If not, the Cirquet Registry (410) will send the latest configuration data of the target Cirquet (412) to the Cirquet run-time environment (405) of the local peer.

If the configuration data of the target Cirquet in the file cache (409) is not up-to-date and valid, the Cirquet run-time environment (405) will replace it with the new configuration data. If the target Cirquet is not instantiated, the Cirquet run-time environment (204) will first instantiate it and then it will pass the message from the original Cirquet (201) to instantiated target Cirquet (412).

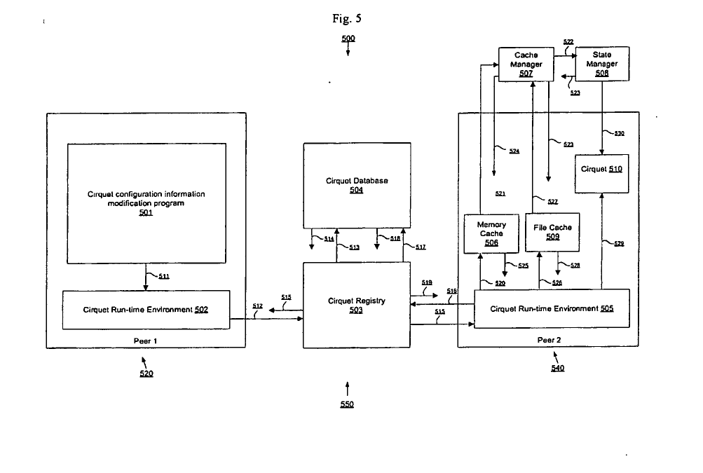

FIG. 5 shows a schematic block diagram of a distributed computing system 500 for dynamically reconfiguring a discreet component application, or Cirquet, 501 at runtime. System 500 includes peers 520 and 540 of peer-to-peer network 550, which may include additional peers.

Cirquet configuration modification program 501 resides on peer 520 and provides the tools or services necessary to make configuration changes to a Cirquet. More than one cirquet configuration modification program may be provided. Cirquet configuration modification program 501 may reside on any peer of network 550 on which a circuet run-time environment resides.

Cirquet run-time environments 502, 505 reside on peer 520, 540, respectively, and provides the types of capabilities of Cirquet run-time environment 204, as described above with reference to FIG. 2. Other peers of peer-to-peer network 550 may have respective run-time environments.

Cirquet registry 503 is provided, having the type of functionality of Cirquet registry 410, described above with reference to FIG. 4. More than one Cirquet registry 503 may be provided.

Cirquet database 504 is provided, having the type of functionality of Cirquet database 411, described above with reference to FIG. 4.

Example 4 describes the process by which a Cirquet is reconfigured with desired changes.

### EXAMPLE 4

Using the tools provided by cirquet configuration modification program (501), the properties of a Cirquet are reconfigured on a local peer. The cirquet configuration modification program (501) sends a message of this configuration change to the local Cirquet run-time environment (502).

The Cirquet run-time environment (502) sends the configuration change message to the Cirquet Registry (503).

The Cirquet registry (503) sends the configuration change message to the Cirquet database (504).

The configuration data of the target Cirquet in the Cirquet database (504) is changed. The Cirquet database sends a message to the Cirquet registry (503) indicating the change.

The Cirquet registry (503) then broadcasts a message to all Cirquet run-time environments (502 and 505) that host the target Cirquet notifying them of the change and invalidating the previous instance of the target Cirquet.

The Cirquet registry (503) then broadcasts a message to all Cirquet run-time environments (502 and 505) that host the target Cirquet notifying them of the change and invalidating the previous instance of the target Cirquet.

The Cirquet Run-time environment (505) invalidates the configuration information data held either in memory cache (506) or in the file cache (509).

Once the Cirquet configuration data is invalidated and depending on where it resides, either the memory cache (506) or the file cache (509) will send a message to the cache manager notifying it that the target Cirquet needs to be released from memory cache (506) or from the file cache (509).

Before releasing the target Cirquet (510) from memory cache (506) or file cache (509), the cache manager (507) will capture the state information of the target Cirquet (510) and send it to the state manager (508) which will hold the information until the modified target Cirquet (510) is updated.

Once the state information of the target Cirquet (510) is stored, the state manager (508) will communicate with the cache manager (507) indicating it is now safe to release the target Cirquet from memory cache (506) or file cache (509).

The Cirquet run-time environment (505) will send a request to the Cirquet registry to retrieve the new configuration data of the target Cirquet.

The Cirquet registry (503) will retrieve the new configuration data of the target Cirquet (510) from the Cirquet database (504) and send the new configuration data of the target Cirquet (510) to the Cirquet run-time environment (505).

The Cirquet run-time environment (505) will update the configuration data of the target Cirquet (510) either in the memory cache (506) or file cache (509) depending on where it originally resided.

The Cirquet run-time environment (505) will then update the properties of the target Cirquet (510). If the code-base or the class files of the target Cirquet have been modified, then the Cirquet run-time environment (505) will re-instantiate the newly modified target Cirquet (510).

Once the target Cirquet (510) is updated or re-instantiated, the state manager (508) will send the state information to the target Cirquet (510).

Code sample 1 provides an example of the code for sending messages between two discreet component applications (Cirquets).

Code Sample 1

```
/**
* PExample.java
*
* This software is the proprietary information of Improv Technologies,
Inc.
* Use is subject to license terms.
*
* Copyright 1999-2002 Improv Technologies, Inc. All Rights Reserved.
*/
import java.awt.event.ActionListener;
import javax.naming.directory.DirContext;
import javax.naming.directory.InitialDirContext;
import org.apache.log4j.Category;
import javax.naming.directory.BasicAttributes;
import javax.naming.NamingException;
import java.awt.event.ActionEvent;
import net.improv.cirquet.*;
import java.util.List;
import java.util.Collections;
import java.util.ArrayList;
import java.util.Iterator;
/**
*
* A simple example illustrating connecting two components together and
* sending messages from one to the other over Cirquet
*/
class PExample {
  private static Category cat = Category.getInstance(PExample.class);
  /** Creates a new instance of PExample */
  public PExample( ) {
    try {
      DirContext context = new InitialDirContext( );
      DirContext registry =
          (DirContext)context.lookup(“crqt://registryhost”);
      // register component 1
      BasicAttributes comp1Attrs = new BasicAttributes( );
      comp1Attrs.put(“cirquet.className”,“ExampleEventGenerator”);
      comp1Attrs.put(“cirquet.codebase”,
          “crqt://registryhost/example.jar”);
      comp1Attrs.put(“cirquet.host”, “crqt://host1”);
      registry.bind(“Component1”, null, comp1Attrs);
      // register component 2
      BasicAttributes comp2Attrs = new BasicAttributes( );
      comp2Attrs.put(“cirquet.className”,“ExampleEventListener”);
      comp2Attrs.put(“cirquet.codebase”,
          “crqt://registryhost/example.jar”);
      comp2Attrs.put(“cirquet.host”, “crqt://host2”);
      registry.bind(“Component2”, null, comp2Attrs);
      CirquetStub comp2stub = (CirquetStub)registry.
      lookup(“Component2”);
      ActionListener comp2proxy =
        (ActionListener)comp2stub.narrow(ActionListener.class);
      // add the listener to component 1 and update
      BasicAttributes comp1Mods = new BasicAttributes( );
      comp1Mods.put(“actionListeners”,
        new ActionListener[] { comp2proxy });
      registry.modifyAttributes(“Component1”,
          DirContext.REPLACE_ATTRIBUTE,
          comp1Mods);
      // get the stub for comp1 and invoke a method on it
      // this causes “got an event” to appear on host2
      CirquetStub comp1Stub =
      (CirquetStub)registry.lookup(“Component1”);
      comp1Stub.invoke(“generateEvent”,null,−1);
      // move component 2 to another host
      BasicAttributes comp2Mods = new BasicAttributes( );
      comp2Mods.put(“cirquet.host”,“crqt://host3”);
      registry.modifyAttributes(“Component2”,
          DirContext.REPLACE_ATTRIBUTE,
          comp2Mods);
      // invoke a method on stub for component 1
      // this causes “got an event” to appear on host3
      comp1Stub.invoke(“generateEvent”,null,−1);
    } catch(NamingException e) {
    cat.error(“”,e);
    }
  }
}
  // Component 1
  class ExampleEventGenerator {
    List actionListeners = Collections.
    synchronizedList(new ArrayList( ));
    public void generateEvent( ) {
      // create a new ActionEvent
      ActionEvent event = new ActionEvent(this,
            ActionEvent.ACTION_PERFORMED,
            “actionPerformed”);
      // send the event to each registered listener
      Iterator iter = actionListeners.iterator( );
      while(iter.hasNext( )) {
        ActionListener listener = (ActionListener)iter.next( );
        listener.actionPerformed(event);
      }
    }
    public void addActionListener(ActionListener listener) {
    if(!actionListeners.contains(listener)) {
      actionListeners.add(listener);
    }
  }
    public void removeActionListener(ActionListener listener) {
    if(actionListeners.contains(listener)) {
      actionListeners.remove(listener);
    }
    }
  public ActionListener[] getActionListeners( ) {
    return (ActionListener[])actionListeners.
    toArray(new ActionListener[0]);
  }
}
// Component 2
class ExampleEventListener implements ActionListener {
  /** Invoked when an action occurs.
  */
  public void actionPerformed(ActionEvent e) {
    System.out.println(“Got an event!”);
  }
}
```

The following paragraphs provide additional information and capabilities of particular embodiments of the present invention, and are intended to be exemplarary and not to limit the scope of the invention:

The Cirquet™ Solution Suite extends the functionality and value of existing technologies and enables dynamic businesses to rapidly and cost effectively develop, deploy and manage scalable, portable distributed applications through its break-through Java™ component-based Cirquet Technology.

The Cirquet Solution Suite is a collection of products and services that deliver dynamic businesses a competitive advantage throughout the entire software lifecycle—increasing the return on investment and extending the value of existing assets.

Like Jini Services, Cirquets are “looked-up” and “discovered” on the network in a fashion similar to Jini, however Cirquet also provides additional services, supporting distributed data storage, dynamic service composition, and collaboration.

Cirquet Applications are assembled by taking any Java™ language component (including JavaBeans™ and Enterprise JavaBeans™) and through an innovation called SmartWrap™ easily transforming them into Cirquets. Cirquets themselves are discrete applications—lightweight, self-contained, portable, Web services. These Cirquets can be assembled “on-the-fly” to create custom Living Software™ applications thus greatly reducing traditional software development cycles.

Cirquet Applications can be easily partitioned and deployed across a variety of architectures from traditional application servers or client-server models to a peer-to-peer scheme. Applications can be deployed on demand based on the needs and resources of the client devices to provide rich user interactions and distributed processing power. Cirquets can be replicated to provide efficient load balancing and migrated to specific peers taking full advantage of under-utilized resources.

While the vast majority of application platforms, tools and technologies are geared toward the creation and management of a service or set of services on a single host, Cirquet Technology enables the centralized management of Cirquet Applications and the individual Cirquets comprising the application to reside on a wide variety of devices and the inter-connections between them. Upgrades, updates and bug fixes can be released into production and propagated across the network to all instances of the service, transparently, without the need to shut down the application, computer or network.

Cirquet Solution Suite is a comprehensive set of innovative products and services that enable complete flexibility and control over the development, deployment and management of distributed applications.

The Cirquet Solution Suite is comprised of the following products:

Cirquet Development Environment Professional Edition (CDE Pro Beta 1.0) contains everything the developer needs to quickly and easily develop and test the deployment of Cirquets and Applications.

Features Benefits

Component based Development Architect once

SmartWrap • Deploy on demand

Dynamic Portable Components Scale at will

“On-the-fly” Assembly • Rapidly customize applications

Tier-to-Peer Deployment Leverage existing development tools

Dynamic Application Configuration Reduce downtime, increase productivity

Interoperate with Legacy Systems Shorten prototype to production cycle

Web Services Architecture Remotely manage distributed applications

Platforms Supported include Windows NT, 2000, XP-Windows 98, ME-Solaris-Linux CO Pro Cirquet Assembly Environment (CAE) installs as a plug-in to popular Integrated Development Environments (IDEs) such as Forte™ for Java™ and allows developers to quickly and easily build Cirquets using their existing Java™ Tools. Cirquet Solution Development Kit (CSDK) provides the foundation upon which Cirquets are built, this includes the runtime environment, application program Cirquet Extensions (CEX) enable Cirquet Applications to integrate and extend existing Web applications. Cirquet Management Console (CMC) manages and deploys Cirquet Applications. Cirquet Directory Services (CDS) manages the registration, authorization, authentication, location and execution of Cirquets on the network. Cirquet Runtime Environments (CRE) on which these tools and Cirquets are deployed: Peers (PC level devices) and Enterprise Peers (E|Peers), server class devices. CDE Pro

The Cirquet Technology is a revolutionary component framework that enables the rapid and cost effective design, development, deployment, management and maintenance of large-scale dynamic network-based distributed applications across a wide variety of platforms, devices and resource capabilities. This is accomplished through the creation of Cirquets—lightweight, self-contained, portable Web services that may be managed remotely, modified and updated at run-time. Cirquets may be hosted on dedicated peers or servers on the network, dynamically migrated across multiple peers to provide efficient load management, or downloaded to client devices, as needed to provide rich user interactions and distributed processing.

Cirquet creates a layer of abstraction between component functionality and component communication across the network. This enables Cirquet to employ fast “in-process” communication for components residing on the same peer and cross-platform XML messaging where components are hosted on different peers on the network, without requiring any additional work on the part of the developer. Cirquet's dynamic deployment capabilities enable components to be distributed, managed and upgraded over a large number of servers, clients and portable devices from a centralized location, eliminating the maintenance issues associated with today's distributed application frameworks. Additionally, and equally important, Cirquet supports existing component methodologies, enabling pre-existing components and components created using well known programming techniques to be immediately available as Cirquet-based Web services, eliminating most of the learning curve normally associated with the creation of network-based applications. In addition, Cirquets contain built-in support that enables them to interoperate with standard (non-Cirquet) Web services, such as those proposed by Microsoft's .NET initiative and the Sun ONE Platform.

The central tenet of Cirquet is that every distributed application could be composed of a vast array of independent components, running anywhere from a small handful of nodes on the network to thousands or even millions of devices. As such, the ability to centrally manage and maintain the network of services that comprise an application is essential. To date, Cirquet is the only solution that makes this possible.

The Cirquet Solution architecture is built upon three elements: Cirquets, the Cirquet Runtime Environment (CRE) and the Cirquet Registry:

A Cirquet is a lightweight, self-contained, portable Web service that consists of:

Cirquet Container holds the configurable properties of the Cirquet, the code base and class files of the Cirquet as well as access control information. All of these can be dynamically configured at run-time without shutting down and recompiling the Cirquet.

Cirquet Component represents the business logic, presentation layer or some other component functionality. This generally comes in the form of a jar file or Java class referencing any Java language component, including Javabeans™ and EJBs™.

Benefits of Cirquets Include:

Cirquets can be assembled into distributed applications “on-the-fly”—developers create distributed applications by assembling pre-compiled Cirquets in a run-time environment. There is no need to shut down, recompile, and re-install whole applications each time new functionality is added.

Cirquets are easy to re-use—because they are self-contained with few external dependencies, Cirquets can be linked to each other in a variety of combinations without the need to write and compile “glue-code.”

Pre-existing components can be easily Cirquet-enabled—any Javabean™ or EJB™ can be published to the Cirquet Network. The Cirquet Runtime Environment (CRE) manages the instantiation of Cirquets on a local peer, the communication between Cirquets, and the monitoring and tracking of Cirquet usage. The CRE sits on top of the Java Virtual Machine (JVM) on each of the peers on a Cirquet-enabled network

Communication between Cirquets—Cirquets residing on the same peer utilize fast “in-process” communication. When residing on different peers, Cirquets will communicate using cross-platform SOAP-based messages. The Cirquet framework supports:

Synchronous and Asynchronous communications between Cirquets

The following networking transports:

HTTP—ubiquitous protocol

JMS—Java Messaging Service

JXTA—lightweight P2P protocol with built in discovery, grouping and security features.

Instantiating Cirquets—The configuration information of a Cirquet and the CRE will determine whether or not a Cirquet is:

Persistently cached whereby the Cirquet remains locally stored until the end user or application administrator removes it.

Transiently cached whereby the Cirquet would remain locally stored for a set period of time or once the peer is shut down. This would generally be done for security reasons and/or to free up device resources when an application is not being used.

Monitoring and Tracking of Cirquet Usage—all usage statistics across a Cirquet network can be monitored and tracked. There are three ways in which can be done:

The CRE can track when and how often a Cirquet is instantiated on a local peer.

The CRE can track when and how often messages are sent between Cirquets.

The Cirquet can be configured to broadcast an event when it is accessed and used.

Benefits of monitoring and tracking:

Developers can use this data to concentrate future development efforts on features needed and requested by users.

3rd party Cirquet developers can use the monitoring and tracking features for billing and licensing purposes.

The Cirquet Registry provides a secure, reliable storage and retrieval facility for Cirquets. It provides the ability to perform the following functions:

Store (“Publish”) new or modified Cirquets to the network—The registry enables a developer to add a descriptor to a component that will automatically assign a unique identifier, effectively converting the Java code into a Cirquet Component. Any Java language component, including Javabeans™ or EJBs™, can be published as a Cirquet to the network.

Locate and Retrieve Cirquets—Cirquets are located by querying the registry the local peer for those that match the desired criteria. If none are found on the local peer, then a search is performed on external registries. Once Cirquets are found, the registry returns a list of optimal matches. Cirquets can then be streamed down to the local peer as needed.

Cache Components—components are locally stored the first time they are accessed so that future uses do not require network resources as they are used. An application executing within the Cirquet Framework streams Cirquets from other peers on the network as needed. Once all the Cirquets are downloaded, the peer can disconnect from the network without adversely affecting the performance of the application. Overall bandwidth consumption from application streaming will be smaller and more balanced because of lazy loading and local execution.

Automatic Cirquet Updating—Cirquets are cached on multiple machines across the network. When a change is made to a Cirquet, all deployed instances of that component are notified and the changes are immediately propagated to the affected peers.

The following illustration shows how Cirquets can be streamed down to reside on local peers and take advantage of fast “in-process” communications.

Architect Once

Using Cirquet, developers need only design their applications once.

Device and Network Neutral

Cirquets and Cirquet Applications can be designed and built independently of the device, transport and communications requirements of the underlying network architecture. Any network appliance that is compatible with a Java 2 Virtual Machine (JVM) can be used as a peer.

Deploy on Demand

Deploying applications built with Cirquets is simply a matter of deciding which Cirquets reside on which peer in the network. Developers have a series of options when deploying the same application:

Cirquets can be streamed down on an “as needed” basis. Instead of all the Cirquets that make up a particular application downloading all at once, they may be downloaded when the particular Cirquet functionality is requested. Over time, the whole application may be cached on the local peer taking advantage of fast “in-process” communications.

Cirquets can be deployed to remain on specific peers across the network for security reasons or to take advantage of the particular resources of the peer. For example, Cirquets that contain sensitive data or functionality (proprietary algorithms, etc) may be deployed only to secure servers and not streamed to local peers. Compute intensive Cirquets may be deployed to remain on peers with adequate processing power.

For resource-constrained devices such as PDAs and wireless telephones, Cirquets may be streamed down one at a time when the particular functionality is required enabling rich, interactive applications. When it has completed its function or is no longer needed, the Cirquet can be dropped from cache to free up memory without disrupting the application.

Scale at Will

With Cirquet, the same resources can be used more efficiently. Because Cirquets can be dynamically configured to reside on any peer on the network, they can be either be:

Migrated to underutilized resources—in order to free up resources placed on a peer due to increased demand for a particular Cirquet or set of Cirquets, developers may choose to migrate less important Cirquets to another peer.

Duplicated across numerous peers to provide adequate load balancing—multiple instantiations of the same Cirquet may reside throughout the network. This lessens the load on any one peer.

Built using Industry Standard Technologies and Practices

Cirquet is built using widely accepted technologies, standards, and software components, such as Java™, JXTA, and XML.

Java™ dynamic object linking—With the Java 2 platform, Cirquet incorporates components at runtime into existing applications, without recompiling the original source code. Cirquet provides a set of core services, as well, with an intuitive interface for the more complex aspects of Java's dynamic programming facilities.

XML (extensible Markup Language)—XML forms the heart of Cirquet's communication model. Component and application meta-data is stored and distributed as XML, and transformed into software components on the client machine. By decoupling a component's properties from its implementation, creators provide multiple component implementations for use on a variety of platforms. This enables application developers to assemble applications tailored to the runtime capabilities status of a particular peer.

SOAP (Simple Object Access Protocol)—the Cirquet Technology uses SOAP as the messaging protocol between all Cirquets. This enables Cirquets to not only communicate with each other, but with any SOAPbased Web services.

Standard Transaction Model—Cirquet provides a distributed transaction model, based on standard ACID (Atomicity, Consistency, Isolation, and Durability) semantics. Therefore, every transaction is guaranteed to complete or not occur at all. Upon completion, the transaction is guaranteed to leave the system in a stable and predictable state. In Cirquet, if a component transaction cannot be completed, due to network failure, Cirquet attempts to access the component through another source. If an additional source cannot be located, the transaction won't initiate and the user is notified of service unavailability. The inherent redundancy of components in Cirquet ensures the highest likelihood of component availability.

Security

Security, authentication, and access control are integral features of the Cirquet Technology. As with any networked environment, the integrity and confidentiality of data are of utmost concern to the user. Cirquet Technology is designed to ensure any data or component transferred between peers must pass through a security layer.

Java Sandbox—The Java 2 security model provides fine-grained control over an application's system resource access. Gaining additional access to resources (the local file system, user information, etc.) requires explicit permission from the user.

Communication over SSL—Communication between objects in Cirquet may occur over Secure Socket Layer (SSL), using the Java 2 Secure Socket Extension (JSSE) where necessary. This protocol employs publicprivate key encryption, generated once an object is published to the network. Any change to a component's data between the time it's published and accessed will result in a failure to decrypt the component at the receiving end.

Communication across corporate firewalls—Communication across corporate firewalls is achieved through a variety of techniques, including transport layer bridges (or port-forwarding), and application proxies, which enable the firewall to direct incoming communication to specific machines on the local network.

Encryption—Components are stored in an encrypted local data store, using the same techniques employed for encrypted communication, which virtually eliminates a user's ability to tamper with cached components. Because all components may not require the same level of security, access controls and other attributes are highly flexible and customizable. The security layer may never be completely bypassed.

Communication across corporate firewalls—Communication across corporate firewalls is achieved through a variety of techniques, including transport layer bridges (or port-forwarding), and application proxies, which enable the firewall to direct incoming communication to specific machines on the local network.

Encryption—Components are stored in an encrypted local data store, using the same techniques employed for encrypted communication, which virtually eliminates a user's ability to tamper with cached components. X Because all components may not require the same level of security, access controls and other attributes are highly flexible and customizable. The security layer may never be completely bypassed.

Integrating Cirquet with Existing Systems

Cirquet can be integrated into existing systems, through the use of tools like JDBC™, JNI™, Javabeans™, and Enterprise Javabeans™ (EJB). The sections to follow explain the roles of each and how they help to achieve this.

Java Database Connectivity (JDBC™) connections to commercial databases—Cirquet Applications are easily integrated with commercial databases, using the Java platform JDBC™ API. The majority of commercial database manufacturers, including Oracle and Sybase, currently support JDBC.

Java Native Interface (JNI™) integration with non-Java applications and components—JNI™ provides developers with the ability to integrate platform-specific components and legacy applications written in C, C++, and other programming languages with Java applications.

Integration of Javabeans™ and Enterprise Javabeans™ (EJB)—Cirquet is built on the Javabeans™ component model, making it easy to integrate any Javabean™ created component into Cirquet. A standard container for EJBs is provided with Cirquet, enabling existing bean deployment into the Cirquet network.

Comparison to Other Component Frameworks

The following sections describe the differences between the Cirquet platform and other existing component based frameworks:

Common Object Request Broker Architecture (CORBA)

Cirquet does not use a remote server model, like CORBA, so components are executed locally by default. Existing CORBA solutions can be integrated into the Cirquet Platform, through the use of RMI-IIOP.

Jini™—Like Jini Services, Cirquets are “looked-up” and “discovered” on the network in a fashion similar to Jini, however Cirquet also provides additional services, supporting distributed data storage, dynamic service composition, and collaboration.

Microsoft's Distributed Component Object Model (DCOM)—Cirquet provides a more dynamic runtime coupling between components in a peer-to-peer networked environment.

Enterprise JavaBeans™—Cirquet, on the other hand, is a platform designed to support the development and deployment of custom component-based distributed applications, at runtime. Cirquet seeks to reduce the need for a central server and attempts harness workstation power to create a peerbased environment for enterprise computing. By using Cirquet, enterprise developers can create distributed enterprise solutions, which scale along with company growth.

The present invention has been described herein with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A discreet component application comprising:
a component; and
a container configured for providing management services to the component.

2. The discreet component application of claim 1 wherein the component includes at least one of a business logic, a presentation logic, and a software functionality.

3. The discreet component application as recited in claim 1 wherein the management services include at least one of holding and controlling configurable properties of the component, holding references to a code base of the component, holding references to a class file of the component, and holding access control information and controlling access to the component.

4. The discreet component application as recited in claim 1 wherein the management services are capable of being dynamically configured at run-time.

5. The discreet component application as recited in claim 1 wherein the management services are capable of being extended at run-time.

6. The discreet component application as recited in claim 1 wherein the discreet component application resides on a peer of a peer-to-peer network.

7. A distributed computing system comprising:
a first discreet component application instantiated on a first peer of a peer-to-peer network; and
a first run-time environment residing on the first peer.

8. The distributed computing system as recited in claim 7 wherein the run-time environment is configured for at least one of 1) managing communications between the first discreet component application and a second discreet component application and 2) instantiating a discreet component application on the first peer.

9. The distributed computing system as recited in claim 7 further comprising a reference stub residing on the first peer, the reference stub being configured for at least one of maintaining a pointer to a second discreet component application and sending a call message to the first run-time environment.

10. The distributed computing system as recited in claim 9 wherein the first discreet component application is further configured for sending an invoke call to the reference stub.

11. The distributed computing system as recited in claim 9 wherein the reference stub is further configured for implementing a proxy for the second discreet component application.

12. The distributed computing system as recited in claim 9 wherein the reference stub is further configured for implementing a proxy for the second discreet component application, and wherein the first discreet component application is further configured for sending a narrow call to the reference stub.

13. The distributed computing system as recited in claim 9 wherein the run-time environment is further configured for packing a message from the reference stub and forwarding the message to a second run-time environment.

14. The distributed computing system as recited in claim 7 wherein the first peer includes a local memory cache configured for storing configuration data of a second discreet component application.

15. The distributed computing system as recited in claim 7 further comprising a cache manager configured for managing the local memory cache.

16. The distributed computing system as recited in claim 7 wherein the first peer includes a local file cache configured for storing configuration data of a second discreet component application.

17. The distributed computing system as recited in claim 7 further comprising a state manager configured for storing state information of the first discreet component application.

18. The distributed computing system as recited in claim 7 further comprising a second discreet component application instantiated on a second peer of the peer-to-peer network and a second run-time environment residing on the second peer.

19. The distributed computing system as recited in claim 7 further comprising a discreet component application registry and a discreet component application database.

20. The distributed computing system as recited in claim 7 further comprising a discreet component application registry and a discreet component application database, wherein the discreet component application database is configured for storing a code-base of at least the first discreet component application.

21. The distributed computing system as recited in claim 7 further comprising a discreet component application registry and a discreet component application database, wherein the discreet component application registry is configured for at least one of 1) managing communication between the first run-time environment and the discreet component application database, 2) locating and retrieving discreet component applications from the discreet component application database, and 3) propagating configuration data regarding the first discreet component application to the first circuit run-time environment.

22. The distributed computing system as recited in claim 7 wherein the run-time environment is configured for at least one of 1) managing communications between the first discreet component application and a second discreet component application and 2) instantiating a discreet component application on the first peer;
wherein the second discreet component application resides on a second peer of the peer-to-peer network.

23. A method for managing a component in a distributed computing system, comprising:
providing the component with a container configured for providing management services to the component so as to form a discreet component application; and
modifying configuration data of the component using configuration data obtained from a discreet application database.

24. The method as recited in claim 23 further comprising using a run-time environment to obtain the configuration data.

25. The method as recited in claim 23 further comprising modifiying properties of the discreet component application on the local peer using a discreet component application configuration information modification program.

26. The method as recited in claim 23 further comprising:
modifiying properties of the discreet component application on the local peer using a discreet component application configuration information modification program; and
sending a message regarding the configuration change to the discreet application database via a discreet application registry using a run-time environment residing on the peer.

27. The method as recited in claim 23 further comprising:
modifying properties of the discreet component application on the local peer using a discreet component application configuration information modification program; and
changing the configuration of the discreet component application in the discreet application database.

28. The method as recited in claim 23 further comprising:
modifying properties of the discreet component application on the local peer using a discreet component application configuration information modification program; and
broadcasting a message regarding the configuration change to run-time environments residing on respective peers of the peer-to-peer network.

29. A distributed computing system comprising:
a first discreet component application instantiated on a first peer of a peer-to-peer network;
a first run-time environment residing on the first peer; and
a discreet component application registry.

30. An apparatus for dynamically reconfiguring a capability of a component in a distributed computing system, the apparatus comprising:
a container configured for providing management services to the component so as to form a discreet component application;
a discreet component application configuration information modification environment configured for making configuration changes to the discreet component application;
a run-time environment configured for managing communications with the discreet component application and for instantiating the discreet component application on a peer of a peer-to-peer network;
a discreet component application database configured for storing a code-base of the discreet component application; and
a discreet component application registry configured for at least one of 1) managing communication between the first run-time environment and the discreet component application database, 2) locating and retrieving discreet component applications from the discreet component application database, and 3) propagating configuration data regarding the first discreet component application to the first circuit run-time environment.

31. A computer readable medium having stored thereon computer executable process steps operative to perform a method for managing a component in a distributed computing system, the method comprising:
providing the component with a container configured for providing management services to the component so as to form a discreet component application; and
modifying configuration data of the component using configuration data obtained from a discreet application database.
